(19) United States
(12) Patent Application Publication
(10) Pub. No.: US 2025/0233809 A1
(43) Pub. Date: Jul. 17, 2025

(54) Location and Time-Based Deep Packet Inspection in Vehicle-Based Network

(71) Applicant: GOGO BUSINESS AVIATION LLC, Broomfield, CO (US)

(72) Inventor: Zhiyong Wang, Vernon Hills, IL (US)

(21) Appl. No.: 18/413,698

(22) Filed: Jan. 16, 2024

(51) Int. Cl. H04L 43/026; H04L 47/11; H04L 67/12

(52) U.S. Cl. CPC H04L 43/026; H04L 47/11; H04L 67/12

(57) ABSTRACT

Systems and methods for applying location- and time-based costs to usage of a vehicle-based network are disclosed. Deep packet inspection (DPI) techniques may be used to generate flow records associating particular usage of the vehicle-based network to respective geographic locations and times during a transit of a vehicle (e.g., an aircraft flight). Network usage cost factors are obtained, the cost factors reflecting predicted and/or observed congestion of the vehicle-based network at respective locations and times. The DPI flow records may be matched with network usage cost factors for corresponding times and locations to determine a congestion-based cost of usage of the vehicle-based network, for example for an individual passenger or a vehicle provider transporting a plurality of passengers.

### FIELD OF THE DISCLOSURE

The present disclosure is related generally to communications in vehicle-based networks. In particular, the present disclosure relates to operating a vehicle-based network based upon congestion in particular locations and times served by the vehicle-based network.

### BACKGROUND

A vehicle, such as an aircraft, may establish one or more satellite-based and/or terrestrial communication links (e.g., cellular links) to exchange communications with one or more ground stations that connect the vehicle to the Internet and/or other wider communication networks. One or more communication links between the vehicle and the ground station(s) may, for example, enable an onboard network at the vehicle to provide live media content, Internet browsing capability, cellular calling, and/or other communication services to passenger-facing electronic computing devices on board the vehicle. In many implementations, the onboard network provides additional services that do not require external communications to/from the vehicle, for example including movies, television programming, etc. that are stored locally at one or more devices onboard the aircraft prior to transit of the vehicle.

Quality of service experienced at passenger electronic computing devices depends upon a number of factors. First, of course, when service at passenger devices involves communications with locations external to the vehicle, quality of service depends upon availability and reliability of the communication link(s) between the vehicle and the external locations, and of course the availability and reliability of the hardware involved therewith. Additionally, though, quality of service at the passenger devices can be affected by congestion (or lack thereof) in the greater communication network(s) (“vehicle-based network”) through which the vehicle to the ground station(s). Congestion may result from a plurality of passenger devices onboard the vehicle using the vehicle-based network at any given time, as the plurality of devices may collectively strain a limited bandwidth of the communication link(s) between the vehicle and the ground station. Congestion can also result from other traffic in a similar geographic location at a similar time (e.g., traffic produced via passenger devices carried on other nearby vehicles, or other devices using the same cell towers, satellites, etc.), as the greater vehicle-based network may only have a limited bandwidth and/or device capacity within any geographic location. Over the course of transit, a vehicle may move between geographic locations experiencing comparatively higher or lower levels of congestion. Accordingly, quality of service at passenger devices over any transit of a vehicle may vary in accordance with the level of congestion in the network(s) supporting the vehicle in the locations traversed during the course of transit. Congestion may adversely affect quality of service at passenger devices, for example, by causing packet loss and/or long buffering or loading times in content transmitted to and/or from the passenger devices.

Conventionally, a customer of onboard communication services is subjected to a cost of usage of the communication services. For example, an individual passenger may pay a predetermined amount to a provider of the vehicle and/or of vehicle-based network to enable the passenger to use communication services over one transit of the vehicle (e.g., one flight of an aircraft). Alternatively, the individual passenger may pay a subscription cost enabling usage of a vehicle-based network across any number of transits during a subscription period (e.g., a per-month subscription cost for access to communication services for any number of flights). Cost of usage of the vehicle-based network can also be attributed to a provider of the vehicle (e.g., owner or operator of an aircraft), which may pay a cost to a provider of vehicle-based network on behalf of a plurality of onboard passenger devices that use communications services during any transit of the vehicle. As with costs for individual passengers, costs for a vehicle owner/provider may be applied via various arrangements, for example via a per-transit cost or a subscription of one vehicle or multiple vehicles to use communication services over a subscription period.

### SUMMARY

The present disclosure considers that congestion in a vehicle-based communication network typically varies based upon time and location, thus potentially adversely affecting quality of service in high-congestion times and locations. More specifically, the present disclosure identifies that network traffic across a vehicle-based network can be analyzed to determine or predict congestion for any particular location at any particular time. Moreover, in some aspects described herein, the network traffic may be analyzed to identify trends representing comparatively high or low-congestion times and/or locations. For example, in a vehicle-based communication network involving aircraft flying over the continental United States, due to usage from passenger devices on a multiplicity of vehicles and/or other ground-based devices, vehicles in the East Coast at mid-day (e.g., 11:00 a.m. to 1:00 p.m.) may experience significantly more network congestion than vehicles in the Central United States during the night hours (e.g., 10:00 p.m. to 4:00 a.m.).

The present disclosure also observes that, although traditional vehicle-based networks may apply cost to customers based upon total data usage, these vehicle-based networks have not applied cost based specifically upon when and where a customer uses communication services. That is, conventionally, if a customer uses a given amount of data volume, the customer is applied a same cost regardless of the date or time at which the customer used the data volume, and regardless of the location of the vehicle when the customer used the data volume.

In view of these observations, the present disclosure describes systems and methods via which cost applied to the customer in a vehicle-based communication network (e.g., cellular and/or satellite-based network) is calculated based upon when and where the customer uses the vehicle-based network. In some aspects, a deep packet inspection (DPI) engine communicatively connected to a plurality of passenger-facing electronic computing devices (“passenger devices”) aboard a vehicle. The DPI engine is configured to analyze any network traffic exchanged between a passenger device and one or more ground stations to determine and record the volume of data downloaded to or uploaded from the passenger device using air-to-ground (ATG) and/or satellite links of the vehicle-based network, the time at which the data was downloaded/uploaded, and the location of the vehicle at the time at which the data was downloaded/uploaded. A network cost computation engine receives records from the DPI engine and applies per-volume usage costs at different respective times and/or locations to calculate a total cost of usage of the vehicle-based network by the passenger device over a transit of the vehicle. The total cost can be used, for example, to apply cost the owner of the passenger device in accordance with their usage, and/or to apply cost to an owner/operator of the vehicle based upon summated network usage costs for a plurality of passenger devices carried by the vehicle during the transit.

By determining and applying varying per-volume network costs based upon time and/or location, the systems and methods of the present disclosure can more effectively account for observed or anticipated congestion in the vehicle-based communication network. Particularly, when congestion is comparatively high in a particular time and/or location, a provider of the network may apply higher per-volume costs to each user in consideration of the potential for each increment of usage to further congest the network and adversely affect the quality of service for each other user. Inversely, when congestion is comparatively low at a particular time and/or location, a provider of the network may apply lower per-volume costs for each user, as each user is using capacity that is more readily available in the vehicle-based network. Moreover, by leading users toward use of communication services at lower-congestion times and/or locations through the offering of comparatively lower per-volume costs, application of the techniques described herein may smooth out the collective usage of the vehicle-based network across times and/or locations to alleviate concentrations of congestion, thereby improving the quality of service for users collectively accessing communication services via the vehicle-based network.

In one aspect, a computer-implemented method may be provided, the method being implemented via one or more computer processors. The computer-implemented method may include (1) obtaining deep packet inspection (DPI) data flow records defining usage of a vehicle-based communication network by one or more passenger devices on board a vehicle during a transit of the vehicle, the DPI data flow records indicating locations and times of the usage of the vehicle-based network, (2) obtaining network congestion data indicating predicted or observed congestion of at least a portion of the vehicle-based network at one or more geographic locations along a route of the transit of the vehicle and at one or more time intervals during the transit of the vehicle, (3) obtaining one or more network usage cost factors based upon the obtained network congestion data, each of the one or more network usage cost factors respectively defining cost of usage of the vehicle-based network within at least one of the one or more locations or the one or more time intervals, (4) comparing the DPI data flow records to the one or more network usage cost factors, to identify corresponding network usage cost factors for the locations and times of usage of the vehicle-based network by the one or more passenger devices, and/or (5) applying the corresponding network usage cost factors to the usage of the vehicle-based network to determine a congestion-based cost of usage of the vehicle-based network for a user of the vehicle-based network. The method may include additional, fewer, and/or alternate actions, including various actions described in this disclosure.

In another aspect, a computing system may be provided. The computing system may include one or more processors, and one or more memories storing non-transitory instructions. The instructions, when executed via the one or more processors, may cause the computing system to (1) obtain deep packet inspection (DPI) data flow records defining usage of a vehicle-based communication network by one or more passenger devices on board a vehicle during a transit of the vehicle, the DPI data flow records indicating locations and times of the usage of the vehicle-based network, (2) obtain network congestion data indicating predicted or observed congestion of at least a portion of the vehicle-based network at one or more geographic locations along a route of the transit of the vehicle and at one or more time intervals during the transit of the vehicle, (3) obtain one or more network usage cost factors based upon the obtained network congestion data, each of the one or more network usage cost factors respectively defining cost of usage of the vehicle-based network within at least one of the one or more locations or the one or more time intervals, (4) compare the DPI data flow records to the one or more network usage cost factors, to identify corresponding network usage cost factors for the locations and times of usage of the vehicle-based network by the one or more passenger devices, and/or (5) apply the corresponding network usage cost factors to the usage of the vehicle-based network to determine a congestion-based cost of usage of the vehicle-based network for a user of the vehicle-based network. The computing system may include additional, fewer, and/or alternate components, including various components described in this disclosure. Moreover, the computing system may be configured to perform additional, fewer, and/or alternate actions, including various actions described in this disclosure.

Advantages will become more apparent to those of ordinary skill in the art from the following description of the preferred aspects, which have been shown and described by way of illustration. As will be realized, the present aspects can be capable of other and different aspects, and their details are capable of modification in various respects. Accordingly, the drawings and description are to be regarded as illustrative in nature and not as restrictive.

### BRIEF DESCRIPTION OF THE DRAWINGS

FIG. 1 depicts an example vehicle communication network environment, according to some aspects of the present disclosure;

FIG. 2A depicts a block diagram of a first example arrangement for obtaining access to a vehicle-based network, according to some aspects of the present disclosure;

FIG. 2B depicts a block diagram of a second example arrangement for obtaining access to a vehicle-based network, according to some aspects of the present disclosure;

FIG. 3A depicts a map of an example transit route over a coverage area of a vehicle-based network, according to some aspects of the present disclosure;

FIG. 3B depicts a first example table of time- and location-based network usage cost factors, according to some aspects of the present disclosure;

FIG. 3C depicts a table calculating time- and location-based network usage cost for the transit of FIG. 3A based upon the cost factors of FIG. 3B, according to some aspects of the present disclosure;

FIG. 3D depicts a second example table of time- and location-based network usage cost factors, according to some aspects of the present disclosure;

FIG. 3E depicts another table calculating time- and location-based network usage cost for the transit of FIG. 3A based upon the cost factors of FIG. 3D, according to some aspects of the present disclosure; and

FIG. 4 depicts a block diagram of an example computer-implemented method, according to some aspects of the present disclosure.

The figures depict aspects of this disclosure for purposes of illustration only. One skilled in the art will readily recognize from the following discussion that alternate aspects of the structures and methods illustrated herein may be employed without departing from the principles set forth herein. The figures are not to scale. Instead, they are drawn to clarify aspects of this disclosure. Connecting lines or connectors shown in the various figures presented are intended to represent example functional relationships, physical couplings, or logical couplings between the various elements. In general, the same reference numbers will be used throughout the drawing(s) and accompanying written description to refer to the same or like parts.

### DETAILED DESCRIPTION

Reference will now be made in detail to the various aspects and aspects of the present disclosure illustrated in the accompanying drawings. Wherever possible, the same or like reference numbers will be used throughout the drawings to refer to the same or like features. Certain terminology is used in the following description for convenience only and is not limiting.

### Example Vehicle Communication Network Environment

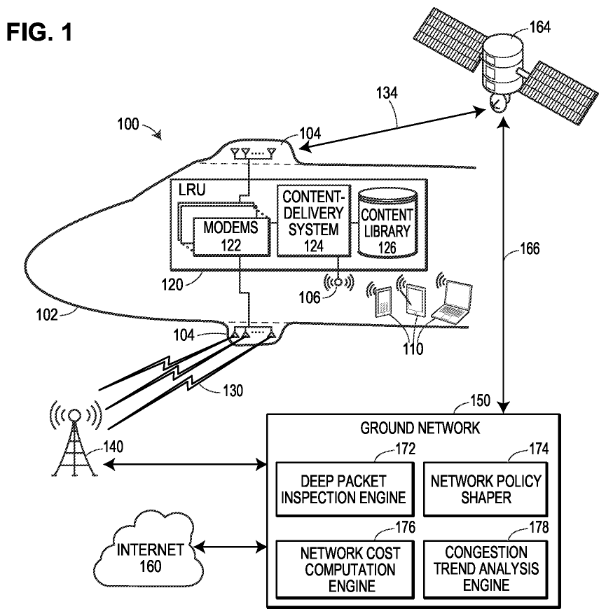

FIG. 1 depicts elements of an example vehicle-based communication network 100 via which the techniques described herein may be implemented, in accordance with some aspects.

The communication network 100 includes an aircraft 102 having one or more mounted antennas 104 that facilitate bidirectional communications between the aircraft 102 (i.e., computing devices within the aircraft 102) and elements outside of the aircraft 102 (e.g., elements on the ground). In the aspect depicted in FIG. 1, one or more antennas 104 are mounted to the belly of the aircraft 102, e.g., to implement one or more air-to-ground (ATG) networks, for example over the S-band, 5G cellular, 4G LTE, and/or other frequencies. Additionally or alternatively, one or more antennas 104 may be mounted to the top of the fuselage of the aircraft 102, e.g., to implement satellite-based communications with elements external to the aircraft 102, for example over the Kᵤ-band, Kₐ-band, L-band, S-band, etc. Additional or fewer antennas 104 are possible, for example mounted to different portions of the aircraft 102, in various aspects. In some aspects, a single aircraft-mounted antenna 104 (or each of one or more antennas 104), may operate to facilitate communications to and from the aircraft 102 via multiple different communications standards (e.g., two or more standards from among 5G, 4G LTE, EVDO, etc.).

Although FIG. 1 depicts an aircraft 102, it should be understood that the systems and methods described herein may be applied to vehicle-based networks involving another type of vehicle, e.g., a personal automobile, bus, train, boat, helicopter, emergency vehicle, subway, etc. In implementations where the vehicle itself is terrestrially based (e.g., a personal automobile, bus, train, etc.), it should be understood that the vehicle “communicating with the ground” and similar terms refer to communications between the vehicle and ground-based network elements external to the vehicle (e.g., ground base stations in the network 100).

The vehicle-based communication network 100 uses the antenna(s) 104 and other onboard network equipment to provide an onboard communication network 106 within the cabin of the aircraft 102 (i.e., one or more communications network, including for example a Wi-Fi network, a cellular network, Bluetooth®, one or more wired networks, etc.). The onboard network 106 enables electronic devices 110 of occupants within the aircraft 102 (“passenger devices 110”) to send and receive data to/from elements external to the aircraft 102, e.g., to browse the Internet, send and/or receive email or text messages, send and/or receive phone calls, and/or consume other media content (e.g., movies, television, news broadcasts, and/or other content, which may include content stored locally at the aircraft 102 and/or content transmitted from the ground).

While not shown in FIG. 1 for clarity of illustration and description of the techniques herein, it should be understood that the aircraft 102 may include electronics systems such as avionics systems, such as communication systems, navigation systems, instrumentation, flight-control systems, or collision avoidance systems, any one or more of which may additionally utilize the onboard communication network 106 (and, in turn, the antenna(s) 104 and other onboard equipment) to send and/or receive communications to and/or from the ground using the vehicle-based network 100. Equivalent electronics systems, including communication systems, navigation systems, etc. may be present on non-aircraft vehicles.

Onboard network equipment of the aircraft 102 providing the onboard network 106 may be included in a line replaceable unit (LRU) 120 that is fixedly or rigidly attached to the aircraft 102. The LRU 120 may be comprised of modular components that may be sealed units which are designed to be replaced within a short time without using specialized tools enabling the aircraft 102 to quickly return to service, while LRU 120 is being tested and repaired. Typically, the LRU 120 is an electronic assembly that performs a specific function in the aircraft 102 and may be removed or replaced as a unit and serviced at a vehicle maintenance center. Some of the electronics systems of the aircraft 102 may not be included in the LRU 120. For example, instead of being fixedly connected to the aircraft 102 via the LRU 120, some electronics systems may be fixedly connected to the aircraft 102 using some other means, such as a bracket or other connecting device. In any case, onboard network equipment of the aircraft 102 includes one or more modems 122, a content delivery system 124, and a content library 126. In some aspects, but not necessarily all aspects, the one or more modems 122 are integrated into the LRU 120.

The one or more modems 122 may be configured to be compatible with a plurality of different communication standards utilized by one or more ATG communication links 130, and/or one or more satellite communication links 134. The one or more ATG communication links 130 may utilize communication protocols associated with terrestrial communications (e.g., TDMA, GSM, CDMA, WiMAX, Wi-Fi, 4G LTE, 5G, etc.) and/or associated with frequencies in the Kₐ band, the Ku band, the L band, and/or any other suitable wireless communication frequency bands, to communicate with one or more ground base stations 140 (e.g., gNBs in a 5G network). The ground base station(s) 140 are communicatively connected to a ground system 150, which may in turn be connected to the Internet 160 and/or other greater communication networks external to the aircraft 102. The one or more satellite communication links 134 may, for example, utilize the Kᵤ-band, Kₐ-band, L-band, S-band, and/or other frequencies, to communicatively connect the aircraft 102 to the ground system 150 (and, in turn, the Internet 160 and/or other networks) via one or more satellites 164 and one or more satellite uplinks/downlinks 166 to the ground system 150 (e.g., via one or more ground base stations such as the base station(s) 140).

Although just ground base station 140 and one satellite 164 are depicted in FIG. 1, it should be understood that the vehicle-base network 100 may in fact include a plurality of ground based stations 140 and/or a plurality of satellites 164. As is understood in the field, communications for a vehicle (e.g., an aircraft 102) may be serviced by one, two, three, four, or more ground base stations and/or satellites over the course of a single transit of the vehicle, as the vehicle passes between coverage regions of respective ones of the ground base stations and/or satellites. Handovers occur as servicing of communications for the vehicle are transitioned from any first ground base station or satellite to any second ground base station or satellite, typically as a link quality between vehicle and the first ground base station or satellite degrades such that linking to the second ground base station or satellite is preferable or necessary.

The content delivery system 124 is configured to, among other things, deliver content to the passenger devices 110 from the stored content library 126 and/or from sources external from the aircraft 102. The content delivery system 124 may be configured to provide an interface to the electronic devices 110 via the onboard communication network 106 to view a list of content, select content, view content, download content, or purchase content or access to content, such as via the Internet 160 or the content library 126. Some examples of provided content include movies, television shows, songs, video games, digital magazines, news feeds, web data, applications, messages, or any other content involving textual, audio and/or visual presentation. The content delivery system 124 may deliver at least some content to the electronic devices 110, e.g. content of the stored content library 126, regardless of its connection to an external network such as the Internet 160. In any event, the content delivery system 124 may communicate with the electronic devices 110, for example, via one or more wired access points and/or wireless access points (WAPs) placed around the cabin of the aircraft 102. The onboard communication network 106 may include additional networking equipment such as routers, hubs, switches, repeaters, bridges, and/or gateway devices. Some of the networking equipment may utilize a spread spectrum paradigm and/or one or more RF bands (e.g., an ISM band, such as the 900 MHz band, 2.4 GHz band or 5 GHz band) to facilitate communication.

The passenger devices 110 may include various personal computing devices, such as smartphones, tablets, laptop computers, personal digital assistants, e-readers, smart glasses, smart watches, and/or various other devices capable of wireless communications within the aircraft 102. In some aspects, passenger devices 110 may additionally or alternatively include seatback computing devices fixedly installed at seats of respective passengers of the aircraft 102. It should be understood that because access to services of seatback computing devices is traditionally provided to a passenger without applying additional cost to the passenger, discussion of time- and/or location-based network usage costs for passengers will focus upon usage of the vehicle-based network 100 by the personal computing devices of passengers. However, still, in some aspects, these techniques for time- and/or location-based application of cost may be applied to usage of seatback computing devices. For instance, in some aspects, a provider of the vehicle-based network 100 may apply costs to a provider of the aircraft 102 for network usage by a plurality of passengers over a transit of the aircraft 102, and the network usage may in some aspects include usage of the seatback computing devices (i.e., usage of ATG and/or satellite links as a result of usage of the seatback computing devices).

Generally speaking, the ground system 150 is positioned between the aircraft 102 and one or more networks external to the aircraft 102 (e.g., the Internet 160), and is configured to analyze and/or process communications between the aircraft 102 and the one or more external networks (e.g., communications from passenger devices 110 to the Internet 160, and/or vice versa). More particularly, the ground system 150 may include, inter alia, modules comprising a deep packet inspection (DPI) engine 172, a network policy shaper 174, a network usage cost computation engine 176, and/or a congestion trend analysis engine 178. The functionalities of each module will be described below. Each of the modules 172, 174, 176, and/or 178 may comprise non-transitory instructions that, when executed via one or more processors associated with the ground system 150, cause the respective module(s) to perform the actions thereof described in this disclosure. Although modules 172, 174, 176, and 178 are depicted separately in FIG. 1, it should be appreciated that aspects of the modules 172, 174, 176, and/or 178 may be combined, in various aspects.

The DPI engine 172 is configured to analyze traffic exchanged between devices on board the aircraft 102 (e.g., the passenger devices 110) and one or more external networks (e.g., the Internet 160). Particularly, the DPI engine 172 analyzes network packets (e.g., IP, ICMP, UDP, and/or TCP packets) or flows of network packets exchanged among the onboard devices and the external network(s) to extract and/or determine particular attributes of the network packets or flows. Based upon the analysis of the network packets or flows, the DPI engine 172 may generate, store, and/or transmit various data structures characterizing the analyzed network packets or flows. For example, for any flow comprising one or more network packets exchanged between a source and destination, the DPI engine may generate a flow record indicating a source IP address, source port, destination IP address, destination port, and communication protocol used in the flow. The source and destination IP addresses (e.g., IPv4 and/or IPv6 addresses) may correspond to an IP address of a passenger device 110 and an IP address of a location in an external network (e.g., a location over the Internet 160), or vice versa. For each flow, the flow record may additionally (or alternatively) indicate a download data volume (e.g., in kilobytes or megabytes), an upload data volume, a download packet count, an upload packet count, a destination hostname, a connected application or category thereof, a count of dropped packets (if any), one or more network policies applied to contents of the data flow, and/or one or more technologies used to transport packets in the data flow.

Still additionally or alternatively, in connection with the time- and/or location-based network cost techniques of the present disclosure, a flow record generated by the DPI engine 172 may include an indication of the time(s) at which network packets were exchanged, and/or the location(s) of the aircraft 102 at the time at which the network packets were exchanged. The time may, for example, identify the precise second, minute, hour, and day of the data flow. The location may, for example, identify the latitude, longitude, elevation, region and/or country at which the aircraft 102 was located at the time of the data flow. Because a passenger device 110 is understood to be on board the aircraft at the time of a data flow, “location of the aircraft 102” and “location of the passenger device 110” are understood to have substantially the same meaning in the context of description of the techniques herein. In consideration of the fact that both the time and the location of the aircraft 102 are likely to change over the course of the data flow, the recorded time and location may be start time and/or location of the data flow, the end time and/or location of the data flow, or any interim time and/or location of the aircraft 102 during the data flow. Thus, where two or more times and/or locations of the aircraft 102 correspond to the data flow, the flow record may identify one, two, or more times and/or locations. In some aspects, network packets analyzed at the DPI engine 172 indicate the time and/or the location of the aircraft 102. Alternatively, in other aspects, the DPI engine 172 receives the time and/or location via other means, e.g., via application programming interface (API) calls to the DPI engine from one or more other module(s) of the ground engine 150. For example, in at least one possible aspect, data flows analyzed at the DPI engine 172 include the time of the data flow, but not the location of the aircraft 102. In these aspects, the DPI engine 172 may receive timestamped locations of the aircraft 102 over a transit (e.g., as indicated by a flight plan or flight record), and may associate data flows with locations by matching times indicated in network packets with times indicated in the timestamped locations of the aircraft 102.

Still other techniques for generating records of network traffic at the DPI engine 172 may be envisioned, in some aspects. For example, in some aspects, rather than generating records of a data flow when the data flow ends, the DPI engine 172 generates records of traffic between any source/destination at fixed, predetermined time intervals (e.g., every one second, three seconds, five seconds, ten seconds, thirty seconds, etc.). Thus, two or more records generated via the DPI engine 172 may correspond to a single flow, or a record generated by the DPI engine 172 may correspond to two or more flows. In any case, usage of various attributes in the flow records generated via the DPI engine 172 will be evident from the description of the time- and/or location-based network cost techniques of the present disclosure.

Via inclusion of the various attributes described above, DPI flow records as described herein may be utilized to facilitate regulatory compliance based upon regulations of territories in which a vehicle provider operates. For example, DPI flow records indicating the time, location, and communication pathway/technology for each data flow (e.g., 4G, 5G, or satellite) may be utilized to ensure or verify compliance with regulatory requirements regarding which communication pathways/technologies are permitted to be active at which times and/or locations.

The network policy shaper 174, generally speaking, may be configured to identify and apply policies to network traffic exchanged between the aircraft 102 (e.g., from the passenger devices 110) and the one or more external networks (e.g., the Internet 160), for example based upon attributes of the network traffic extracted via the DPI engine 172. The network policy shaper 174 may, for example, be configured to allow and/or block particular sources/destinations, ports, protocols, technologies and/or applications. Additionally or alternatively, the network policy shaper 174 may be configured to apply different data transmission rates and/or priorities to particular volumes of data transmitted to or from any particular passenger device 110. Various techniques for network policy shaping, based upon deep packet inspection and/or other attributes, are described in each of (1) U.S. Pat. No. 11,757,737, entitled “Dynamic Routing and Policy Shaping for Aggregated Network” and filed Feb. 22, 2023, and (2) U.S. patent application Ser. No. 18/231,167, entitled “Closed Loop Aircraft Level Dynamic Shaper with Fairness” and filed Aug. 7, 2023. The entire disclosure of each of the aforementioned documents is hereby incorporated by reference herein.

The network usage cost computation engine 176 is configured to calculate and apply cost of usage of the vehicle-based network 100 by respective customers (e.g., by any particular passenger and/or by an owner/provider of the aircraft 102). Particularly, in some aspects described herein, the network cost computation engine 176 calculates and applies cost of network usage based upon times and/or locations of the aircraft 102 during the network usage, as indicated by the flow records generated via the DPI engine 172. Accordingly, the network cost computation engine 176 may comprise one or more data structures (e.g., tables, curves, formulae, etc.) defining costs or cost modifiers (e.g., cost multipliers) associated with respective usage times and/or usage locations, particularly based upon expected or observed network congestion and the times and/or locations. The network cost computation engine applies the one or more cost-defining data structures to flow records corresponding to any particular customer to summate the cost of network usage by the particular customer over a transit (or multiple transits) of the aircraft 102. Subsequent portions of the present disclosure will provide various examples of cost-defining data structures that the network cost computation engine 176 may apply to flow records generated via the DPI engine 172. The network cost computation engine 176 may apply the calculated cost in various manners, for example by applying cost to a customer in accordance with the customer's network usage for a particular transit, determining or updating a flat usage license cost for a particular transit, or determining or updating a cost of subscription for a customer for multiple transits in one or more locations for a particular duration of time (e.g., a cost monthly subscription for a passenger or a provider of the aircraft 102 within a particular country or region).

The congestion trend analysis engine 178 is configured to analyze usage of the vehicle-based network 100 (e.g., as indicated by flow records generated via the DPI engine 172) to determine levels of congestion of the vehicle-based network 100. Particularly, the congestion trend analysis engine 178 may determine congestion associated with the communication link(s) connecting the aircraft 102 to the one or more external networks (e.g., the Internet 160). These one or more communication links may for example include the ATG link(s) 130, the connection(s) 134 and the aircraft 102 and the satellite(s) 164, and/or the uplink(s)/downlink(s) 166 between the satellite(s) 164 and the ground. Congestion of a particular communication link may be expressed, for example, as a used amount of communication bandwidth or a proportion of used communication bandwidth relative to a traffic handling capacity of the particular communication link.

By determining the network congestion across multiple transits of one or more aircraft 102, the congestion trend analysis engine 178 may for example identify higher or lower peak, minimum, or average congestion associated with any particular geographic location(s) or any particular times (e.g., times of day, days of the week, month, or year, etc.). In some aspects, the congestion trend analysis engine 178 uses past network traffic data (e.g., indicating congestion) to project future levels of congestion in the vehicle-based network 100. Even more particularly, in some aspects, the congestion trend analysis engine 178 may use one or more machine learning techniques to train one or more processing elements to predict future congestion of the vehicle-based network 100 at any particular location(s) and/or time(s), based upon training data indicative of past congestion of the vehicle-based network 100 at particular location(s) and/or time(s). In these aspects, the congestion trend analysis engine 178 may be configured to test predicted congestion of the vehicle-based network 100 against further received data indicative of actual network congestion at the corresponding location(s)/time(s), e.g. as indicated by flow records generated via the DPI engine 172.

Output of the congestion trend analysis engine 178 may be applied to update cost-defining data structures at the network cost computation engine 176, to thereby update the time- and/or location-based cost determination techniques described herein to more accurately reflect changing conditions of the vehicle-based network 100. Congestion and other changes in the vehicle-based network may occur, for example, based upon increased transit traffic in a geographic area or time, or as a result in change in usage volumes/patterns among other devices on the ground utilizing the ground base station(s) 140 and/or satellite(s) 164. For example, where the congestion trend analysis engine 178 identifies a comparatively higher level of congestion at a particular location and/or time, the congestion trend analysis engine 178 causes the network cost computation engine 176 to update the one or more cost-defining data structures to apply a higher cost at the particular location or time. Inversely, where the congestion trend analysis engine 178 identifies a comparatively lower level of congestion at a particular location and/or time, the congestion trend analysis engine 178 causes the network cost computation engine 176 to update the one or more cost-defining data structures to apply a lower cost at the particular location or time. Moreover, in some aspects, output of the congestion trend analysis engine 178 is provided to the network policy shaper 174 to determine or update policies to be applied to network traffic based upon experienced or predicted congestion of the vehicle-based network 100 (e.g., to adjust bitrates or handling of potential dropped packets responsive to congestion or lack of congestion).

It should be appreciated that the vehicle-based network 100 as depicted in FIG. 1 shows just some possible aspects of systems for time- and/or location-based application of usage costs in a vehicle-based network. Various additions, subtractions, and/or alterations to the network 100 are possible, in various possible aspects. Particularly, in many possible aspects, the network 100 involves not just one but instead many vehicles, including aircraft, other vehicles, and/or combinations thereof.

### Example Arrangements for Access to Vehicle-Based Network

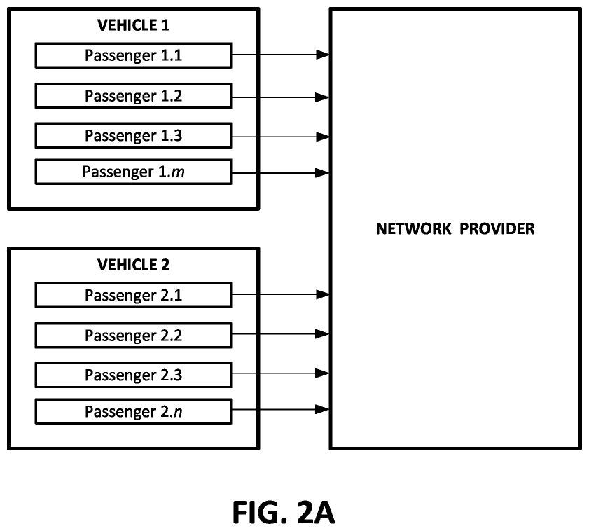

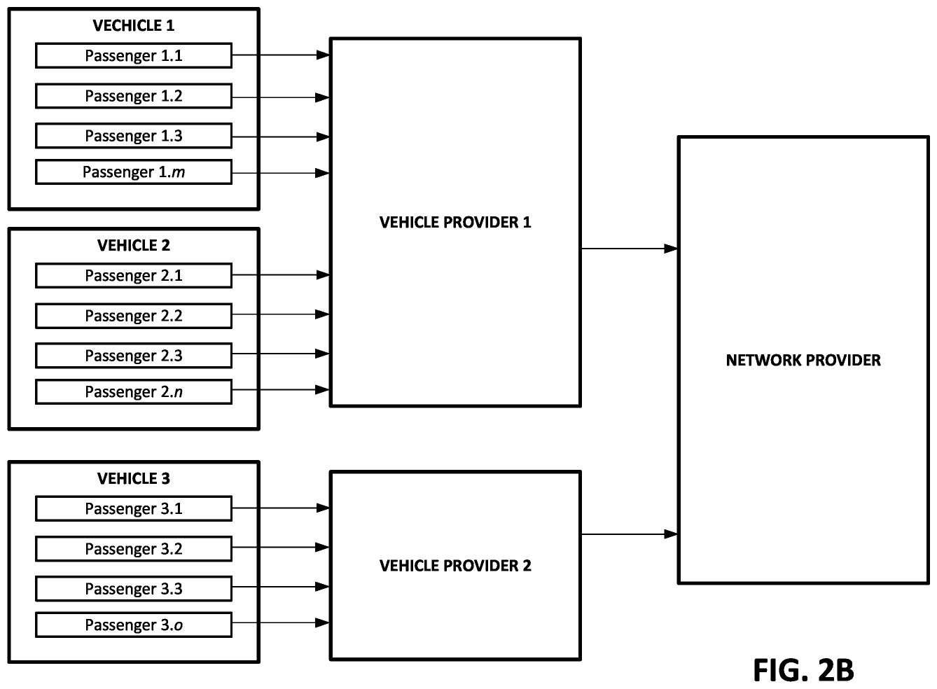

To provide examples of how time- and/or location-based costs may be applied to usage of a vehicle-based network (e.g., the network 100 of FIG. 1), FIGS. 2A and 2B depict block diagrams of example arrangements via which passengers on board vehicles may obtain access to communication services in the vehicle-based network. In each of FIGS. 2A and 2B, unidirectional arrows generally represent a flow of compensation (e.g., payment) from a first entity to a second entity, in exchange for the second entity providing back to the first entity equipment and/or services to facilitate access to the vehicle-based network. As will be understood, time- and/or location-based costs according to the techniques of this disclosure may be applied to any number of access arrangements as discussed below.

Referring first to FIG. 2A, a network provider provides access to a vehicle-based communication network at each of vehicles 1 and 2 (and/or any additional number of vehicles, which may include aircraft and/or other vehicles described in this disclosure). The network provider provides access to the network, for example, via provision of necessary hardware and/or software on board vehicles 1 or 2 and/or on the ground, provision of network access applications at devices of passengers on board, and/or handling of network traffic on board and/or on the ground. Each of passengers 1.1-1.m on board vehicle 1 and passengers 2.1-2.n on board vehicle 2 achieves access to the vehicle-based network over a transit of the corresponding vehicle by interfacing with the network provider. A passenger may, for example, purchase access to the vehicle-based network before boarding the vehicle. Alternatively, a passenger may be directed toward purchase of access during flight, for example via a software application executing at a passenger device, and/or via a captive network that may limit access to communications at a passenger device until the passenger has purchased access and/or signed in to the vehicle-based network (e.g., by redirecting web requests to an access purchase and/or login page of the network provider).

In some implementations of systems and methods for applying varying time- and/or location-based network usage costs, the network usage costs may be applied to the compensation provided by passengers 1.1-1.m and passengers 2-1-2.n to the network provider. In at least one possible implementation, each of passengers 1.1-1.m pay a first network access price (e.g., a flat network access cost or a per-volume usage cost) and each of passengers 2.1-2.n pay a second, different network access price. The different respective network access prices for vehicles 1 and 2 may be based, for example, upon scheduled transit schedules of vehicles 1 and 2, respectively. For example, the first network access price for passengers 1.1-1.m may be lower than the second network access price for passengers 2.1-2.m, based upon vehicle 1 being scheduled to transit during lower-congestion times and/or in lower-congested locations, as compared to vehicle 2. Additionally or alternatively, in some implementations, at least a portion of the network access price (e.g., a flat single-transit access fee, a per-volume network usage cost, or a subscription cost) is the same for all passengers 1.1-1.m and 2.1-2.n, for example based upon analysis of historical network usage by passengers across a multiplicity of vehicles served by the network provider. Still additionally or alternatively, in some possible implementations, at least a portion of network access cost paid by each passenger is calculated subsequent to the transit of the corresponding vehicle, based upon the specific usage of the vehicle-based network by the passenger (i.e., calculated after-the-fact, based upon the passenger's own network usage, for example based upon at which time(s) and/or location(s) the passenger consumed data via usage of the vehicle-based network).

In some implementations, aspects of the above techniques are combined. For example, a network access price for passenger 1.1 may be partly calculated a priori based upon a price determined for all passengers 1.1-1.m on board vehicle 1, and partly after-the-fact based upon time- and/or location-based usage cost specific to passenger 1.1. It is considered, though, that preferable implementations may include those where a network access price (e.g., flat single-transit network access cost, per-volume usage cost, or subscription cost) for a particular passenger is fully calculated a priori, such that any particular passenger is fully aware of the network access price before purchasing access to the vehicle-based network.

Moving now to FIG. 2B, it is considered that, in alternative arrangements, passengers on board vehicles 1, 2, and 3 purchase access to the vehicle-based network by providing payment not directly to the network provider, but instead to vehicle providers 1 and 2 (e.g., owners and/or operators of respective sets of one, two, three, or more vehicles). That is, passengers 1.1-1.m on board vehicle 1 and passengers 2.1-2.n on board vehicle 2 pay a network access price to vehicle provider 1, and passengers 3.1-3.o pay a network access price to vehicle provider 2 (e.g., via similar described above with respect to FIG. 2A, for example via a software application of the vehicle provider). Each of vehicle providers 1 and 2, in turn, pay an aggregate network price to the network provider to enable the vehicle provider to provide communication services to passengers served by vehicle providers 1 and 2.

In further possible implementations of techniques of this disclosure, aggregate network prices paid by the vehicle providers 1 and 2 to the network provider vary based upon time and/or location of usage of the vehicle-based network. For example, in some implementations, an aggregate network price paid by vehicle provider 1 is calculated after-the-fact based upon time and/or location of network usage by passengers 1.1-1.m and passengers 2.1-2.n during one or more transits of each of vehicles 1 and 2. Likewise, aggregate network price paid by vehicle provider 2 may be determined based upon time and/or location of network usage by passengers 3.1-3.o during one or more transits of vehicle 3. Alternatively, in some aspects, aggregate network prices paid by each vehicle provider are determined a priori based upon transit schedules of corresponding vehicles for each network provider (e.g., based upon the expected times and/or locations of transit in combination with expected or average network usage behaviors of passengers on board each transit).

In any case, a first aggregate network price (e.g., a group subscription cost, per-transit cost, or per-volume cost) paid by vehicle provider 1 to the network provider may differ from a second aggregate network price paid by vehicle provider 2, based upon the times and/or locations at which the vehicle(s) of each vehicle provider have traveled or are expected to travel. Moreover, while the vehicle providers 1 and 2 in FIG. 2B aspects pay aggregate network prices on behalf of passengers based upon time and/or location, various network access arrangements are possible for the passengers themselves. For example, passengers on board vehicles of the vehicle providers 1 and 2 may access the vehicle-based network by paying a network access price that varies based upon time and/or location, or a network access price that does not vary at all (e.g., same network access price for all passengers of a vehicle provider). In some implementations, access to the vehicle-based network is free of cost from the perspective of passengers, with vehicle provider 1 and/or 2 absorbing and paying the cost of network usage to the network provider. These network access arrangements for passengers can be applied without the need to calculate usage costs for individual passengers based upon time and/or location, thus creating price transparency from the perspective of passengers. Moreover, regulatory requirements in some jurisdictions may restrict the creation of network usage records on the individual level, and thus, it would be preferred in such jurisdictions to aggregate and price network usage from the vehicle rather than the more granular level of the individual passengers.

In short, implementations of the techniques of this disclosure are compatible with a variety of arrangements for purchasing access to the vehicle-based network, without deviating from the concept of determining and applying different costs for usage of a vehicle-based network based upon when and where a passenger(s) use the vehicle-based network. Where particular examples will be discussed in further detail in subsequent portions of this disclosure, it should be appreciated that various augmentations and/or modifications to the examples may be envisioned to adapt these examples to any of the variety of arrangements discussed with respect to FIGS. 2A and/or 2B, and/or to incorporate other techniques discussed in this disclosure. Example Transit Use Cases with Time- and Location-Based Network Usage Costs

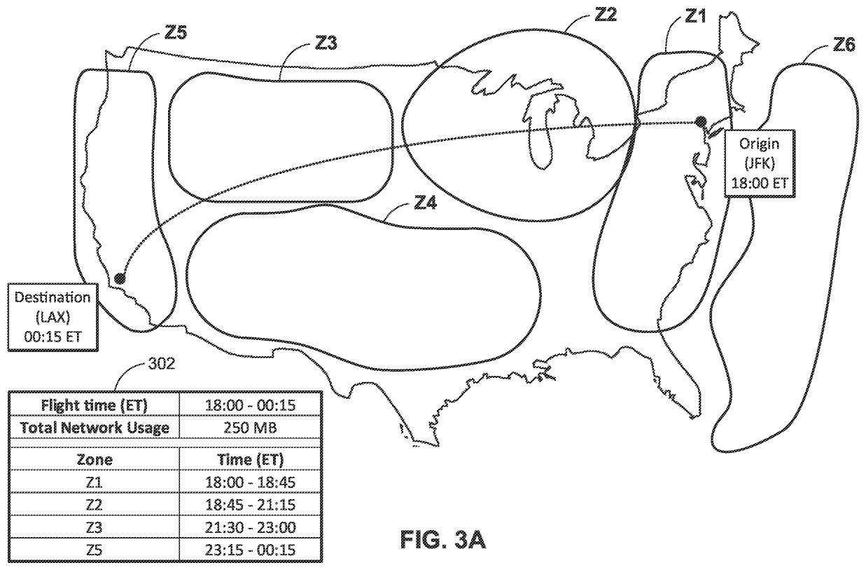

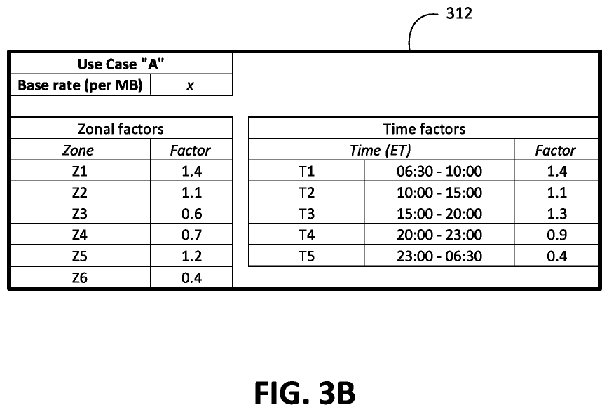

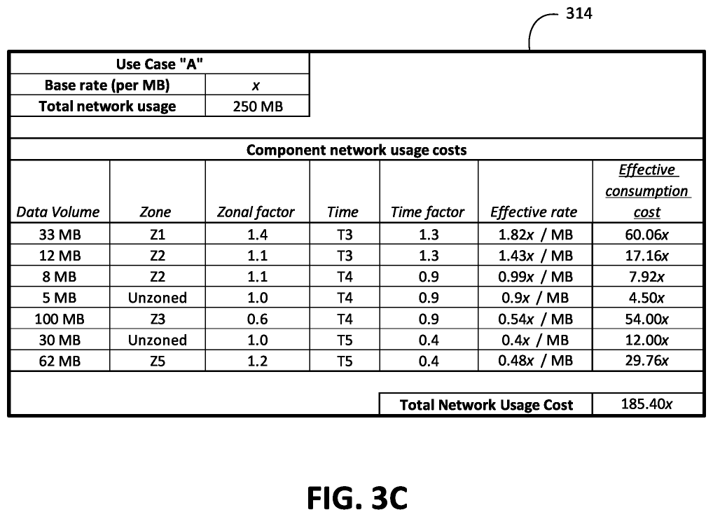

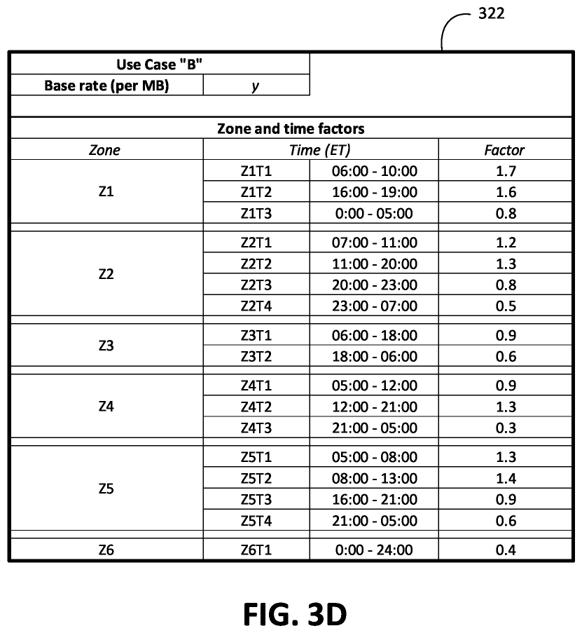

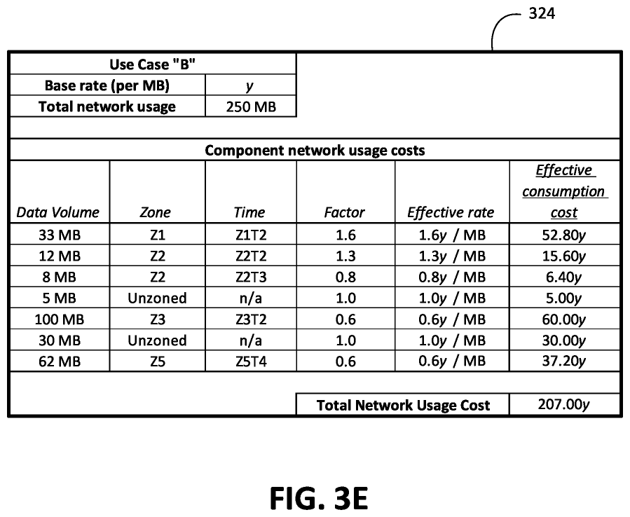

FIGS. 3A-3E depict example use cases involving time- and location-based network costs applied to usage of a vehicle-based network, for an example flight depicted in FIG. 3A originating at John F. Kennedy International Airport in New York City (JFK) and arriving at Los Angeles International Airport in Los Angeles (LAX). FIG. 3A depicts the flight path overlaid on a map of the continental United States and surrounding regions. FIG. 3A notes departure time from of 18:00 eastern time (ET) from JFK and an arrival time to LAX at 00:15 ET of the next day, for a total flight time of six hours and fifteen minutes. For ease of description, all times with reference to FIGS. 3A-3E will be provided in eastern time, notwithstanding that the geographic regions shown in FIG. 3A comprise other geographic time zones (e.g., actual local time of arrival at LAX is 21:15 PT). Over the course of the flight depicted in FIG. 3A, an example customer of the vehicle-base network uses 250 megabytes (MB) of data in communications between the aircraft and the ground over the vehicle-based network (e.g., through use of web browsing, email messaging, video/audio streaming, and/or other applications). In the example of FIGS. 3A-3E, the customer is presumed to be a passenger using a personal electronic computing device (though, as noted in the foregoing, a customer may correspond to more than one passenger or a vehicle provider).

In the example use cases of FIGS. 3A-3E, six location ranges or “zones” Z1 through Z6 are established over the map of the continental United States and surrounding territory. As will be described in further detail below, each of zones Z1 through Z6 has respective vehicle-based network usage cost factors associated therewith, e.g. in light of the network congestion or lack thereof in each zone. For the example use cases of FIG. 3A-E, it will be presumed that no unique location-based usage cost factors apply to those locations in the map not covered by any of zones Z1 through Z6 (“unzoned locations,” e.g., having a default location-based usage cost factor). Although just six zones are depicted for ease of description, it should be appreciated that implementations across the geographic scale shown in FIG. 3A may in fact include tens, hundreds, or even thousands of zones each having their own respective network usage cost factors. Zones may correspond, for example, to coverage areas of respective cell towers in an ATG network, or to respective ones of multiple sectors therein. In some implementations, a footprint of the vehicle-based network is entirely divided into zones, whereas alternatively as depicted in FIG. 3A, some locations in the vehicle-based network may not be assigned a zone. Accordingly, zones may be contiguous (i.e., sharing borders) or noncontiguous.

In implementations of deep packet inspection (DPI) techniques of this disclosure, location of the aircraft with reference to defined zones may be determined based upon DPI flow records of passenger devices which, as described in the foregoing, include the location of the passenger devices or aircraft for any given data flow. For example, coordinates recorded the DPI flow (e.g., latitude, longitude, elevation, country, region, etc.) may be compared to the geographic definitions of zones (e.g., along any one or more of the same parameters) to determine the zonal location of the aircraft. Additionally or alternatively, the zonal location of the aircraft may be determined based upon flight plans and/or navigation instrument readings of the aircraft. In these aspects, a DPI engine (e.g., engine 172 of FIG. 1) may for example incorporate location into a DPI flow record by cross-referencing a time included in the DPI flow record to a location of the aircraft at the identical time based upon the flights plans and/or navigation instrument readings.

In any case, on the example flight route of FIG. 3A, the aircraft begins in zone Z1 and proceeds into a contiguous zone Z2. After departing the western portion of zone Z2, the aircraft briefly transits through an unzoned location before arriving in the eastern end of zone Z3. After exiting zone Z3 and briefly entering another unzoned location, the aircraft enters and remains in zone Z5 until landing. Table 302 in the bottom-left corner of FIG. 3A displays the example times during which the aircraft is within each of the zones Z1, Z2, Z3, and Z5 from the origin to the destination. The aircraft does not enter either of zone Z4 over the southern United States or Z6 over international waters east of the United States.

Moving to FIG. 3B, a table 312 provides location- and time-based network usage cost factors according to a use case A. Table 312 may, for example, be among the cost-defining data structure(s) stored by the network cost computation engine 176 of FIG. 1. Use case A provides a base usage cost x per megabyte (MB) of data consumed (e.g., uploaded and/or downloaded) by the user, and respective zonal usage cost factors for each of the zones Z1 through Z6 of FIG. 3A. For example, usage of the vehicle-based network is priced at 1.4x per MB in the relatively congested zone Z1, whereas network usage is priced at 0.6x and 0.4x per MB in the comparatively less congested zones Z3 and Z6. Unzoned locations may be presumed to have a network usage cost factor of 1.0, effectively matching the base per-MB cost rate x. The value of x may be set, by example, by the network provider, based upon various considerations.

In addition to location-based usage cost factors, the use case A of FIG. 3B implements time-based usage cost factors T1 through T5 across all locations served by the vehicle-based network. For example, viewed agnostically to location of the aircraft, usage cost from comparatively congested hours of 06:30 to 10:00 ET is 1.4x per MB, whereas usage cost from comparatively less congested hours of 23:00-06:30 ET is 0.4x per MB. In implementations where not all times are covered by unique time factors, the time factor may be presumed to be a default of 1.0.

According to the use case A of FIG. 3B, the cost of network usage at any particular time and location can be obtained by multiplying the appropriate time factor for the particular time with the appropriate zonal factor for the particular location. For example, network usage in zone Z1 at time T1 is priced at 1.4-times-1.4x, or 1.96x per MB, meaning that network usage at the most congested combination of time and location is priced at almost double the base per-MB rate. By contrast, network usage in zone Z1 at time T5 is priced at 1.4-times-0.4x, or 0.56x per MB, making network usage at this time and location substantially less expensive than the base rate. Examining one of the comparatively less congested or lower-priced zones, by contrast network usage costs in zone Z3 may range from a low of 0.24x (0.6-times-0.4x at time T5) to a high of 0.84x (0.6-times-1.4x at T1) per MB consumed.

As depicted in a table 314 of FIG. 3C, a location/time-based cost of 250 MB of data consumption by the user during the flight of FIG. 3A can be calculated by referencing DPI flow records of the user's network usage to the table 312 of FIG. 3B (e.g., via the network cost computation engine 176 based upon flow records generated/stored by the DPI engine 172 of FIG. 1). Total network usage cost for the 250 MB consumed is calculated by summing component network usage cost for portions of data consumed in each zone and time. Each component network usage cost respectively may reflect a number of data flows indicated by DPI flow records for the corresponding location and time (e.g., one, two, three, five, ten, one hundred, or one thousand data flows). For example, a zone factor for Z1 and a time factor for T3 are applied to 33 MB of data consumption, creating an effective consumption cost of 60.06x (1.82x per MB) within that time and zone. As the aircraft moves into zone Z2, the per-MB rate decreases even within the same time T3, then decreases even further when the aircraft remains in zone Z2 at time T4. Similar component calculations occur for all remaining combinations of zone and time until landing at LAX. For unzoned locations, a default zone factor of 1.0 is applied. The component network usage costs in the right-most column are combined to produce a total network usage cost of 185.40x for the user's 250 MB total data consumption over the flight. Notably, because the user consumed disproportionate amounts of data at comparatively less expensive (e.g., less congested) zones and times, the total network usage cost in table 314 is less than that which would be applied had the base per-MB rate x been applied to all 250 MB data consumption without regard to time or location of usage.

In view of the above, a table 322 depicted in FIG. 3D depicts a second possible implementation of location and time-based network usage costs, in an example use case B. In this second implementation, rather than having same time-based cost factors applied to a base cost y across all locations, table 322 provides different time-based cost factors for each one of zones Z1 through Z6. For example, zone Z1 applies cost factors Z1T1, Z1T2, and Z1T3 for usage at various hours of the day, whereas zone Z2 applies a different set of cost factors Z2T1 through Z2T4 based upon an entirely different daily time schedule. Zones Z3, Z4, and Z5 implement still different time-based cost factors, whereas still another zone Z6 uses a same cost factor at all hours of the day. For times not defined in table 322 (e.g., 10:00 to 16:00 in Z1, or 13:00 to 16:00 in Z5), it may be presumed that a default cost factor of 1.0 applies to data consumed at a particular location and time. Likewise, for coverage areas of the vehicle-based network not defined by a zone, it may be presumed that the default factor of 1.0 applies regardless of time.

Thus, compared to the use case A described with respect to FIG. 3B, the use case B in FIG. 3D accounts for varying time-based patterns of congestion (and hence, network cost) in different ones of the zones Z1 through Z6. For example, it may be found that while zone Z1 experiences congestion focusing around times 06:00-10:00 and 16:00-19:00 (as well as a generally higher congestion across the zone overall), zone Z3 may experience less variance in congestion and thus price network usage more smoothly across all hours of a day. Zone Z6, meanwhile, may experience little to no time-based congestion patterns at all, and thus may price network usage at a same rate regardless of time.

As depicted in a table 324 of FIG. 3E, a location/time-based cost of the same 250 MB of data consumption during the flight of FIG. 3A under use case B can be calculated by referencing DPI flow records of the user's network usage to the table 322 of FIG. 3D (e.g., via the network cost computation engine 176 based upon flow records generated/stored by the DPI engine 172 of FIG. 1). Each component network usage cost respectively may reflect a number of data flows indicated by DPI flow records for the corresponding location and time. Network usage cost for the 250 MB consumed in use case B is calculated by summing component network usage cost for portions of data consumed at each combination of zone and time shown in the table 324, producing a total cost of 207.00y for the 250 MB of data consumption. Thus, comparing table 324 to the table 314 of FIG. 3C, different total network usage costs may be incurred based upon whether each zone defines its respective time-based cost factors, or if instead same time factors are applied to all locations (or at least multiple zones) in a coverage area of the vehicle-based network. Once again, though, from FIG. 3E, it is observed that network usage cost using these techniques may be lower than that which would be calculated from applying the base rate of y to all usage, particularly when network usage is steered toward comparatively lower-congestion times and/or locations.

Although the foregoing provides examples of some techniques for applying location- and/or time-based network usage costs, numerous modifications or augmentations may be envisioned. For example, instead of or in addition defining time-based cost factors based upon time of day, time-based cost factors may be applied based upon days of week or month, months of the year, and/or other time-based delineations. Moreover, modifications to costs (e.g., cost factors) may be applied based upon still other factors in addition to the location and/or time factors described above. For example, in some aspects, different per-MB data costs (e.g., cost factors) may be applied to downloading and uploading of data (respectively) to or from a passenger device. Additionally or alternatively, in some aspects, different per-MB data costs (e.g., cost factors) may be applied depending on the communication pathway/technology and/or frequency used to transport data (e.g., 3G, 4G LTE, 5G, satellite, etc.), and/or the application via which the passenger device consumed (i.e., uploaded or downloaded) data (e.g., social media, email, calling, video streaming, audio streaming applications, etc.).

In some aspects, a first volume of network usage for a particular customer over a transit may be priced differently from a second volume of network over the same transit for the same customer. For example, referring back to the flight described with respect to FIG. 3A, a first 50 MB of data (or a different amount) consumed by a passenger's device(s) may be free of cost regardless of time and/or location, and subsequent network usage may be priced according to the cost-defining data structures described with respect to FIGS. 3B-3E. In another example, the first volume of network usage (e.g., 50 MB) may be priced at a same rate regardless of the time- and/or location-based factors that apply to subsequent network usage (e.g., no more than the default rate of x or y from FIGS. 3B and 3D, respectively, unless time- and/or location-based rates offer a discount). As still another example, network usage during a single transit beyond the 250 MB described with respect to FIGS. 3A-3E (or a different amount) may be priced via a further cost factor (e.g., a further multiplier of the time and/or location factors described in the foregoing).

In some aspects, network usage rates applied to a customer are modified further based upon quality of service provided to the customer. For example, where DPI flow records provide an indication of dropped packets, network response times, or other attributes measuring quality of service, discounts to network usage rates may be applied when these recorded attributes indicate inconvenient network experiences for some or all of the transit of a customer.

Determining Time- and/or Location-Based Network Usage Cost Factors

As described with respect to the foregoing features, it is envisioned that time- and/or location-based usage factors should reflect the real usage conditions of the vehicle-based network with respect to the factors are implemented. For example, with respect to the example implementations proposed with respect to FIG. 3A-3E, a higher factor(s) is/are generally applied to zone Z1 in response to (or, alternatively, in anticipation of) congestion in zone Z1 being greater than that in other zones, for example due to the presence of a greater number of vehicles and/or other network users in zone Z1. Likewise, in both of use cases A and B described with respect to FIGS. 3A-3E, mid-morning and mid-evening times are generally priced higher in response to (or in anticipation of) congestion being greater at those hours than in other hours of each day. However, in practice, real congestion conditions in the vehicle-based network are subject to change over time, for example due to the addition or removal of capacity in the vehicle-based network, addition or subtraction of network users and/or devices, or the redistribution of users and devices across locations and times served by the network.

In view of the changing congestion conditions in the vehicle-based network, techniques are proposed herein for determining past congestion and/or predicting future congestion of a vehicle-based network. Generally speaking, these determinations and/or predictions of congestion can be used, for example, to generate or modify cost factors associated with use of the vehicle-based network (e.g., time- and/or location-based factors as discussed with respect to FIGS. 3A-3E). These techniques may be implemented, for example, at the ground system 150 of FIG. 1, or more particularly at the congestion trend analysis engine 178, alone or in combination with other aspects of the ground system 150 or the environment 100 more generally.

In some aspects, network usage information regarding usage of the vehicle-based network during transit of one or more vehicles is collected and stored. The stored usage information may reflect usage of the vehicle-based network by devices on board the one or more vehicles. The stored usage information may, for example, indicate data throughput volume and/or rate from onboard devices, quality of service parameters from onboard devices, usage of respective communication channels by onboard devices (e.g., satellite, 4G, 5G, etc.). Additionally or alternatively, stored usage information may indicate the usage of shared aspects of the vehicle-based network outside of the one or more vehicles (i.e., by devices not associated with the vehicle(s) and the transit thereof). The stored usage information may, for example, indicate data throughput, quality of service, and respective communication channel usage by other network devices sharing the same cellular towers, satellite infrastructure, etc. as the onboard devices. In any case, the stored network usage information may be labeled with time and/or location (e.g., latitude, longitude, elevation, zone, region, country, etc.). Labeled network usage information may be analyzed to measure or classify a level of congestion in the network for any time and location. Congestion-based costs for usage of the vehicle-based network may be applied to customers (e.g., individual passengers or vehicle operators) after-the-fact based upon the measured/classified levels of congestion for times and locations at which onboard devices consumed data in the vehicle-based network. Particularly, in some aspects, time- and/or location-based cost factors may be generated and applied at any desired level of granularity based upon observed congestion at the corresponding time and/or location (e.g., observed congestion can be measured for a particular month, day, hour, minute, etc., or for any particular country, state, square mile, etc.).

Additionally or alternatively, in some aspects, time- and/or location-based network cost factors are generated and/or modified based upon predicted congestion of the vehicle-based network at particular locations and/or particular times in the future. For example, the congestion trend analysis engine 178 may identify higher or lower peak, minimum, or average congestion associated with any particular geographic location(s) or any particular times (e.g., times of day, days of the week, month, or year, etc.), and determine that these trends are likely to continue to apply to future operation of the vehicle-based network. Thus, higher or lower time- and/or location-based cost factors may be applied based upon predicted future congestion based upon observed past congestion of the vehicle-based network. In some aspects, machine learning techniques are used to train one or more processing elements to predict future congestion of the vehicle-based network and/or to generate/modify cost factors based upon training data indicative of past usage and/or congestion of the network. For example, unsupervised machine learning techniques may supply past network usage information to the one or more processing elements, which may identify trends in the past network usage information to facilitate prediction of future congestion. As another example, using supervised machine learning techniques, the one or more processing elements may be supplied with training data indicating time, location, and/or other conditions in the vehicle-based network, with the training data being labeled with the corresponding measurement or classification of congestion in the vehicle-based network or a portion thereof. Applying supervised machine learning techniques using the training data, the one or more processing elements may be trained to measure or classify congestion based upon test data sets reflecting similar conditions in the network other than congestion. In any case, predicted congestion in the vehicle-based network at particular times and/or locations may be used to generate and/or modify time- and/or location-based network usage cost factors in accordance with anticipated congestion.

Via these techniques, the cost factors to be applied to any particular flight may be known a priori. In some aspects, customers of the vehicle-based network are notified of time- and/or location-based cost factors before or upon accessing the vehicle-based network. Additionally, the congestion trend analysis engine 178 may be configured to test predicted congestion of the vehicle-based network 100 against further received data indicative of actual network congestion at the corresponding location(s)/time(s), e.g. as indicated by flow records generated via the DPI engine 172.

In any case, it is envisioned that, by generating, modifying, and applying time- and/or location-based cost factors for usage of the vehicle-based network based upon network congestion, systems and methods herein may alleviate stress on the vehicle-based network, e.g., by explicitly or implicitly directing passengers toward usage of the network at non-peak times and locations through the offering of lesser cost for non-peak times and locations. Furthermore, these practices may improve user experience at passenger devices accessing the network, as passengers using devices in low-congestion times and locations may find greater data throughput, less packet loss, and other positive quality of service indicators at those times and locations.

### Example Computer-Implemented Methods

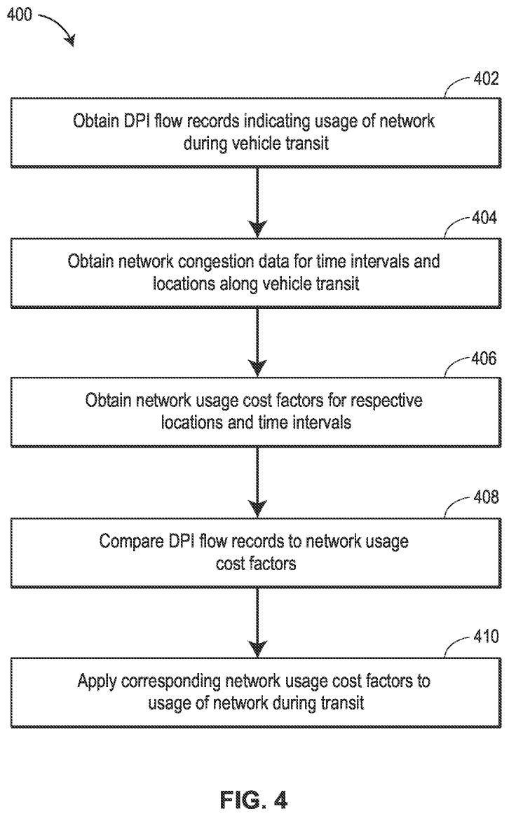

In view of the foregoing, FIG. 4 depicts an example computer-implemented method 400, in accordance with some aspects of the present disclosure. The computer-implemented method 400 may be performed, for example, via aspects of the ground system 150 of FIG. 1 (e.g., the DPI engine 172, network shaper 174, network cost computation engine 176, and/or congestion trend analysis engine 178). Accordingly, the method 400 may be performed via one or more computer processors executing non-transitory instructions stored at one or more computer memories. In some aspects, one or more computer readable media store non-transitory instructions that, when executed via one or more computers, cause the one or more computers to perform actions of the method 400.

The method 400 includes obtaining deep packet inspection (DPI) data flow records defining usage of a vehicle-based communication network (402). Particularly, the data flow records may define usage of the network by one or more passenger devices on board a vehicle (e.g., an aircraft) during a transit of the vehicle. The DPI data flow records may indicate locations and times of the usage of the vehicle-based network. In some aspects, the DPI data flow records may indicate various other attributes of respective data flows (e.g., application, upload/download, communication pathway/technology used, etc.).

The method 400 further includes obtaining network congestion data indicating congestion of at least a portion of the vehicle-based network at one or more geographic locations along a route of the transit of the vehicle and at one or more time intervals during the transit of the vehicle (404). The network congestion data may indicate predicted congestion (e.g., predicted based upon past activity in the vehicle-based network) and/or observed congestion during the transit (e.g., based upon the DPI flow records and/or other network usage information for the vehicle-based network).

The method 400 still further includes obtaining one or more network usage cost factors based upon the obtained network congestion data (406). Each of the one or more network usage cost factors respectively may define cost of usage of the vehicle-based network within at least one of the one or more locations or the one or more time intervals. Various techniques may be utilized to define the network usage cost factors, including for example any of the techniques described with respect to FIGS. 3A-3E. Generally speaking, though, the network usage cost factors may correspond to predicted or observed congestion during the corresponding locations and time intervals.

The method 400 still yet further includes comparing the DPI data flow records to the one or more network usage cost factors, to identify corresponding network usage cost factors for the locations and times of usage of the vehicle-based network by the one or more passenger devices (408). Effectively, each data flow in the DPI data flow records may be analyzed to match an indicated time and location to one or more network usage cost factors.

The method 400 further includes applying the corresponding network usage cost factors to the usage of the vehicle-based network to determine a congestion-based cost of usage of the vehicle-based network for a user of the vehicle-based network (410). The user may, for example, be an individual passenger paying for usage of the vehicle-based network at one or more personal devices, or a vehicle provider paying for usage of the vehicle-based network on behalf of one or more transported passengers. Network usage costs may be applied according to various techniques described in this disclosure, including for example any of the techniques described with respect to FIGS. 2A, 2B, and/or 3A-3E. A network usage cost may, for example, be a single-transit network usage cost for a passenger or a vehicle provider (priced via flat fee and/or per-volume usage), or a subscription cost for a passenger or a vehicle provider.

The method 400 may include still additional, fewer, and/or alternate actions, including various actions described in this disclosure.

### Additional Considerations

Use of “a” or “an” are employed to describe elements and components of the aspects herein. This is done merely for convenience and to give a general sense of the description. This description, and the claims that follow, should be read to include one or at least one and the singular also includes the plural unless it is obvious that it is meant otherwise. A device or structure that is “configured” in a certain way is configured in at least that way but may also be configured in ways that are not listed.

Further, as used herein, the expressions “in communication,” “coupled” and “connected,” “communicatively coupled,” etc. including variations thereof, encompasses direct communication and/or indirect communication through one or more intermediary components, and does not require direct mechanical or physical (e.g., wired) communication and/or constant communication, but rather additionally includes selective communication at periodic intervals, scheduled intervals, aperiodic intervals, and/or one-time events. The aspects are not limited in this context.

Further still, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

Moreover, in the foregoing specification, specific aspects have been described. However, one of ordinary skill in the art appreciates that various modifications and changes can be made in view of aspects of this disclosure without departing from the scope of the invention as set forth in the claims below. Accordingly, the specification and figures are to be regarded in an illustrative rather than a restrictive sense, and all such modifications made in view of aspects of this disclosure are intended to be included within the scope of present teachings.

Additionally, the benefits, advantages, solutions to problems, and any element(s) that may cause any benefit, advantage, or solution to occur or become more pronounced are not to be construed as a critical, required, or essential features or elements of any or all the claims.

Finally, any references, including, but not limited to, publications, patent applications, and patents cited herein are hereby incorporated in their entirety by reference to the same extent as if each reference were individually and specifically indicated to be incorporated by reference and were set forth in its entirety herein.

The patent claims at the end of this patent application are not intended to be construed under 35 U.S.C. § 112(f) unless traditional means-plus-function language is expressly recited, such as “means for” or “step for” language being explicitly recited in the claim(s). The communication systems and methods described herein are directed to improvements to computer and communication system functionality and performance.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

This detailed description is to be construed as exemplary only and does not describe every possible aspect, as describing every possible aspect would be impractical, if not impossible. One could implement numerous alternate aspects, using either current technology or technology developed after the filing date of this application.

By way of example, and not limitation, the disclosure herein contemplates at least the following aspects:

1. A computer-implemented method implemented via one or more processors, the method comprising: obtaining deep packet inspection (DPI) data flow records defining usage of a vehicle-based communication network by one or more passenger devices on board a vehicle during a transit of the vehicle, the DPI data flow records indicating locations and times of the usage of the vehicle-based network; obtaining network congestion data indicating predicted or observed congestion of at least a portion of the vehicle-based network at one or more geographic locations along a route of the transit of the vehicle and at one or more time intervals during the transit of the vehicle; obtaining one or more network usage cost factors based upon the obtained network congestion data, each of the one or more network usage cost factors respectively defining cost of usage of the vehicle-based network within at least one of the one or more locations or the one or more time intervals; comparing the DPI data flow records to the one or more network usage cost factors, to identify corresponding network usage cost factors for the locations and times of usage of the vehicle-based network by the one or more passenger devices; and applying the corresponding network usage cost factors to the usage of the vehicle-based network to determine a congestion-based cost of usage of the vehicle-based network for a user of the vehicle-based network.

2. The computer-implemented method of aspect 1, wherein the one or more network usage cost factors comprise (i) one or more location factors defining cost of using the vehicle-based network within respective ones of the one or more locations, and (ii) a separately defined one or more time factors defining cost of using the vehicle-based network within respective ones of the one or more time intervals.

3. The computer-implemented method of aspect 2, wherein applying the corresponding network usage factors to the usage of the vehicle-based network comprises: identifying one of the one or more location factors corresponding to a subset of the usage of the vehicle-based network; identifying one of the one or more time factors corresponding to the subset of the usage of the vehicle-based network; and applying the identified location factor and the identified time factor to the subset of the usage of the vehicle-based network to determine a congestion-based cost of the subset of the usage of the vehicle-based network.

4. The computer-implemented method of aspect 3, wherein applying the identified location factor and the identified time factor comprises applying the identified location factor and the identified time factor to a base usage cost rate of the vehicle-based network.

5. The computer-implemented method of any one of aspects 1 to 4, wherein the one or more network usage cost factors comprise a plurality of composite cost factors, each of the composite cost factors defining respective cost of usage of the vehicle-based network at a combination of a particular one of the one or more locations and a particular one of the one or more time intervals.

6. The computer-implemented method of aspect 5, wherein applying the corresponding network usage factors to the usage of the vehicle-based network comprises: identifying, from among the plurality of composite cost factors, a particular composite cost factor corresponding to a subset of usage of the vehicle-based network; and applying the identified composite cost factor to the subset of the usage of the vehicle-based network to determine a congestion-based cost of the subset of the usage of the vehicle-based network.

7. The computer-implemented method of aspect 6, wherein applying the identified composite cost factor comprises applying the identified composite cost factor to a base usage cost rate of the vehicle-based network.

8. The computer-implemented method of any one of aspects 1 to 7, wherein obtaining the network congestion data comprises obtaining the network congestion data subsequent to the transit and indicates observed congestion in the vehicle-based network, and wherein obtaining the one or more network usage cost factors comprises generating the one or more network usage cost factors based upon the observed congestion in corresponding ones of the one or more geographic locations and the one or more time intervals.

9. The computer-implemented method of any one of aspects 1 to 8, wherein obtaining the network congestion data comprises predicting congestion of the at least a portion of the vehicle-based network at the one or more geographic locations and the one or more time intervals, and wherein obtaining the one or more network usage cost factors comprises generating the one or more network usage cost factors based upon the predicted congestion in corresponding ones of the one or more geographic locations and the one or more time intervals.

10. The computer-implemented method of aspect 9, wherein predicting the congestion of the vehicle-based network comprises applying one or more machine learning techniques to information indicative of past usage of the vehicle-based network.

11. The computer-implemented method of any one of aspects 1 to 10, wherein the user of the vehicle-based network is a passenger on board the vehicle, and wherein the one or more passenger devices comprise one or more personal electronic computing devices corresponding to the passenger.

12. The computer-implemented method of any one of aspects 1 to 10, wherein the user of the vehicle-based network is a provider of the vehicle, and wherein the DPI data flow records define usage of the vehicle-based network by respective passenger devices of a plurality of passengers served by the vehicle provider.

13. The computer-implemented method of any one of aspects 1 to 12, wherein the vehicle is an aircraft.

14. A computing system comprising: one or more processors; and one or more memories storing non-transitory instructions that, when executed via the one or more processors, cause the computing system to: obtain deep packet inspection (DPI) data flow records defining usage of a vehicle-based communication network by one or more passenger devices on board a vehicle during a transit of the vehicle, the DPI data flow records indicating locations and times of the usage of the vehicle-based network; obtain network congestion data indicating predicted or observed congestion of at least a portion of the vehicle-based network at one or more geographic locations along a route of the transit of the vehicle and at one or more time intervals during the transit of the vehicle; obtain one or more network usage cost factors based upon the obtained network congestion data, each of the one or more network usage cost factors respectively defining cost of usage of the vehicle-based network within at least one of the one or more locations or the one or more time intervals; compare the DPI data flow records to the one or more network usage cost factors, to identify corresponding network usage cost factors for the locations and times of usage of the vehicle-based network by the one or more passenger devices; and apply the corresponding network usage cost factors to the usage of the vehicle-based network to determine a congestion-based cost of usage of the vehicle-based network for a user of the vehicle-based network.

15. The computing system of aspect 14, wherein the one or more network usage cost factors comprise (i) one or more location factors defining cost of using the vehicle-based network within respective ones of the one or more locations, and (ii) a separately defined one or more time factors defining cost of using the vehicle-based network within respective ones of the one or more time intervals.

16. The computing system of aspect 15, wherein the instructions to apply the corresponding network usage factors to the usage of the vehicle-based network comprise instructions to: identify one of the one or more location factors corresponding to a subset of the usage of the vehicle-based network; identify one of the one or more time factors corresponding to the subset of the usage of the vehicle-based network; and apply the identified location factor and the identified time factor to the subset of the usage of the vehicle-based network to determine a congestion-based cost of the subset of the usage of the vehicle-based network.

17. The computing system of aspect 16, wherein the instructions to apply the identified location factor and the identified time factor comprise instructions to apply the identified location factor and the identified time factor to a base usage cost rate of the vehicle-based network.

18. The computing system of any one of aspects 14 to 16, wherein the one or more network usage cost factors comprise a plurality of composite cost factors, each of the composite cost factors defining respective cost of usage of the vehicle-based network at a combination of a particular one of the one or more locations and a particular one of the one or more time intervals.

19. The computing system of aspect 18, wherein the instructions to apply the corresponding network usage factors to the usage of the vehicle-based network comprise instructions to: identify, from among the plurality of composite cost factors, a particular composite cost factor corresponding to a subset of usage of the vehicle-based network; and apply the identified composite cost factor to the subset of the usage of the vehicle-based network to determine a congestion-based cost of the subset of the usage of the vehicle-based network.

20. The computing system of aspect 19, wherein the instructions to apply the identified composite cost factor comprise instructions to apply the identified composite cost factor to a base usage cost rate of the vehicle-based network.

21. The computing system of any one of aspects 14 to 20, wherein the instructions to obtain the network congestion data comprise instructions to obtain the network congestion data subsequent to the transit and indicates observed congestion in the vehicle-based network, and wherein the instructions to obtain the one or more network usage cost factors comprise instructions to generate the one or more network usage cost factors based upon the observed congestion in corresponding ones of the one or more geographic locations and the one or more time intervals.

22. The computing system of any one of aspects 14 to 21, wherein the instructions to obtain the network congestion data comprise instructions to predict congestion of the at least a portion of the vehicle-based network at the one or more geographic locations and the one or more time intervals, and wherein the instructions to obtain the one or more network usage cost factors comprise instructions to generate the one or more network usage cost factors based upon the predicted congestion in corresponding ones of the one or more geographic locations and the one or more time intervals.

23. The computing system of aspect 22, wherein the instructions to predict the congestion of the vehicle-based network comprise instructions to apply one or more machine learning techniques to information indicative of past usage of the vehicle-based network.

24. The computing system of any one of aspects 14 to 23, wherein the user of the vehicle-based network is a passenger on board the vehicle, and wherein the one or more passenger devices comprise one or more personal electronic computing devices corresponding to the passenger.

25. The computing system of any one of aspects 14 to 23, wherein the user of the vehicle-based network is a provider of the vehicle, and wherein the DPI data flow records define usage of the vehicle-based network by respective passenger devices of a plurality of passengers served by the vehicle provider.

26. The system of any one of aspects 14 to 25, wherein the vehicle is an aircraft.

27. The method of any one of aspects 1 to 13, performed via the system of any suitable one of aspects 14 to 26.

28. The system of any one of aspects 14 to 26, configured to perform the method of any suitable one of aspects 1 to 13.

29. Any one of aspects 1 to 28, in combination with any other suitable one of aspects 1 to 28.

What is claimed:

1. A computer-implemented method implemented via one or more processors, the method comprising:
obtaining deep packet inspection (DPI) data flow records defining usage of a vehicle-based communication network by one or more passenger devices on board a vehicle during a transit of the vehicle, the DPI data flow records indicating locations and times of the usage of the vehicle-based network;
obtaining network congestion data indicating predicted or observed congestion of at least a portion of the vehicle-based network at one or more geographic locations along a route of the transit of the vehicle and at one or more time intervals during the transit of the vehicle;
obtaining one or more network usage cost factors based upon the obtained network congestion data, each of the one or more network usage cost factors respectively defining cost of usage of the vehicle-based network within at least one of the one or more locations or the one or more time intervals;
comparing the DPI data flow records to the one or more network usage cost factors, to identify corresponding network usage cost factors for the locations and times of usage of the vehicle-based network by the one or more passenger devices; and
applying the corresponding network usage cost factors to the usage of the vehicle-based network to determine a congestion-based cost of usage of the vehicle-based network for a user of the vehicle-based network.

2. The computer-implemented method of claim 1, wherein the one or more network usage cost factors comprise (i) one or more location factors defining cost of using the vehicle-based network within respective ones of the one or more locations, and (ii) a separately defined one or more time factors defining cost of using the vehicle-based network within respective ones of the one or more time intervals.

3. The computer-implemented method of claim 2, wherein applying the corresponding network usage factors to the usage of the vehicle-based network comprises:
identifying one of the one or more location factors corresponding to a subset of the usage of the vehicle-based network;
identifying one of the one or more time factors corresponding to the subset of the usage of the vehicle-based network; and
applying the identified one of the one or more location factors and the identified one of the one or more time factors to the subset of the usage of the vehicle-based network to determine a congestion-based cost of the subset of the usage of the vehicle-based network.

4. The computer-implemented method of claim 3, wherein applying the identified one of the one or more location factors and the identified one of the one or more time factors comprises applying the identified one of the one or more location factors and the identified one of the one or more time factors to a base usage cost rate of the vehicle-based network.

5. The computer-implemented method of claim 1, wherein the one or more network usage cost factors comprise a plurality of composite cost factors, each of the composite cost factors defining respective cost of usage of the vehicle-based network at a combination of a particular one of the one or more locations and a particular one of the one or more time intervals.

6. The computer-implemented method of claim 5, wherein applying the corresponding network usage factors to the usage of the vehicle-based network comprises:
identifying, from among the plurality of composite cost factors, a particular composite cost factor corresponding to a subset of usage of the vehicle-based network; and
applying the identified one of the plurality of composite cost factors to the subset of the usage of the vehicle-based network to determine a congestion-based cost of the subset of the usage of the vehicle-based network.

7. The computer-implemented method of claim 6, wherein applying the identified one of the plurality of composite cost factors comprises applying the identified one of the plurality of composite cost factors to a base usage cost rate of the vehicle-based network.

8. The computer-implemented method of claim 1, wherein obtaining the network congestion data comprises obtaining the network congestion data subsequent to the transit and indicates observed congestion in the vehicle-based network,
and wherein obtaining the one or more network usage cost factors comprises generating the one or more network usage cost factors based upon the observed congestion in corresponding ones of the one or more geographic locations and the one or more time intervals.

9. The computer-implemented method of claim 1, wherein obtaining the network congestion data comprises predicting congestion of the at least a portion of the vehicle-based network at the one or more geographic locations and the one or more time intervals,
and wherein obtaining the one or more network usage cost factors comprises generating the one or more network usage cost factors based upon the predicted congestion in corresponding ones of the one or more geographic locations and the one or more time intervals.

10. The computer-implemented method of claim 9, wherein predicting the congestion of the vehicle-based network comprises applying one or more machine learning techniques to information indicative of past usage of the vehicle-based network.

11. The computer-implemented method of claim 1, wherein the user of the vehicle-based network is a passenger on board the vehicle, and wherein the one or more passenger devices comprise one or more personal electronic computing devices corresponding to the passenger.

12. The computer-implemented method of claim 1, wherein the user of the vehicle-based network is a provider of the vehicle, and wherein the DPI data flow records define usage of the vehicle-based network by respective passenger devices of a plurality of passengers served by the vehicle provider.

13. The computer-implemented method of claim 1, wherein the vehicle is an aircraft.

14. A computing system comprising:
one or more processors; and
one or more memories storing non-transitory instructions that, when executed via the one or more processors, cause the computing system to:
obtain deep packet inspection (DPI) data flow records defining usage of a vehicle-based communication network by one or more passenger devices on board a vehicle during a transit of the vehicle, the DPI data flow records indicating locations and times of the usage of the vehicle-based network;
obtain network congestion data indicating predicted or observed congestion of at least a portion of the vehicle-based network at one or more geographic locations along a route of the transit of the vehicle and at one or more time intervals during the transit of the vehicle;
obtain one or more network usage cost factors based upon the obtained network congestion data, each of the one or more network usage cost factors respectively defining cost of usage of the vehicle-based network within at least one of the one or more locations or the one or more time intervals;
compare the DPI data flow records to the one or more network usage cost factors, to identify corresponding network usage cost factors for the locations and times of usage of the vehicle-based network by the one or more passenger devices; and
apply the corresponding network usage cost factors to the usage of the vehicle-based network to determine a congestion-based cost of usage of the vehicle-based network for a user of the vehicle-based network.

15. The computing system of claim 14, wherein the one or more network usage cost factors comprise (i) one or more location factors defining cost of using the vehicle-based network within respective ones of the one or more locations, and (ii) a separately defined one or more time factors defining cost of using the vehicle-based network within respective ones of the one or more time intervals.

16. The computing system of claim 15, wherein the instructions to apply the corresponding network usage factors to the usage of the vehicle-based network comprise instructions to:
identify one of the one or more location factors corresponding to a subset of the usage of the vehicle-based network;
identify one of the one or more time factors corresponding to the subset of the usage of the vehicle-based network; and
apply the identified one of the one or more location factor and the one of the one or more identified time factors to the subset of the usage of the vehicle-based network to determine a congestion-based cost of the subset of the usage of the vehicle-based network.

17. The computing system of claim 16, wherein the instructions to apply the identified one of the one or more location factors and the identified one of the one or more time factors comprise instructions to apply the identified one of the one or more location factors and the identified one of the one or more time factors to a base usage cost rate of the vehicle-based network.

18. The computing system of claim 14, wherein the one or more network usage cost factors comprise a plurality of composite cost factors, each of the composite cost factors defining respective cost of usage of the vehicle-based network at a combination of a particular one of the one or more locations and a particular one of the one or more time intervals.

19. The computing system of claim 18, wherein the instructions to apply the corresponding network usage factors to the usage of the vehicle-based network comprise instructions to:
identify, from among the plurality of composite cost factors, a particular composite cost factor corresponding to a subset of usage of the vehicle-based network; and
apply the identified one of the plurality of composite cost factors to the subset of the usage of the vehicle-based network to determine a congestion-based cost of the subset of the usage of the vehicle-based network.

20. The computing system of claim 19, wherein the instructions to apply the identified one of the plurality of composite cost factors comprise instructions to apply the identified one of the plurality of composite cost factors to a base usage cost rate of the vehicle-based network.

21. The computing system of claim 14, wherein the instructions to obtain the network congestion data comprise instructions to obtain the network congestion data subsequent to the transit and indicates observed congestion in the vehicle-based network,
and wherein the instructions to obtain the one or more network usage cost factors comprise instructions to generate the one or more network usage cost factors based upon the observed congestion in corresponding ones of the one or more geographic locations and the one or more time intervals.

22. The computing system of claim 14, wherein the instructions to obtain the network congestion data comprise instructions to predict congestion of the at least a portion of the vehicle-based network at the one or more geographic locations and the one or more time intervals,
and wherein the instructions to obtain the one or more network usage cost factors comprise instructions to generate the one or more network usage cost factors based upon the predicted congestion in corresponding ones of the one or more geographic locations and the one or more time intervals.

23. The computing system of claim 22, wherein the instructions to predict the congestion of the vehicle-based network comprise instructions to apply one or more machine learning techniques to information indicative of past usage of the vehicle-based network.

24. The computing system of claim 14, wherein the user of the vehicle-based network is a passenger on board the vehicle, and wherein the one or more passenger devices comprise one or more personal electronic computing devices corresponding to the passenger.

25. The computing system of claim 14, wherein the user of the vehicle-based network is a provider of the vehicle, and wherein the DPI data flow records define usage of the vehicle-based network by respective passenger devices of a plurality of passengers served by the vehicle provider.

26. The system of claim 14, wherein the vehicle is an aircraft.
